(19) United States
(12) Patent Application Publication
(10) Pub. No.: US 2012/0234472 A1
(43) Pub. Date: Sep. 20, 2012

(54) HOCKEY STICK AND RELATED METHOD OF MANUFACTURE

(75) Inventors: Gregory Isaac Garcia, San Diego, CA (US); Jared Jonas Quartuccio, San Diego, CA (US)

(73) Assignee: WARRIOR SPORTS, INC., Warren, MI (US)

(21) Appl. No.: 13/047,652

(22) Filed: Mar. 14, 2011

(51) Int. Cl. B65H 81/06; B29C 70/34

(52) U.S. Cl. 156/194; 156/245

(57) ABSTRACT

A composite hockey stick and related method of manufacture is provided. The hockey stick includes a blade joined with a tapered and elongated hosel that is further joined with an elongated handle or shaft. The method includes providing a cured blade, bladder-molding the elongated hosel while partially seated within the cured blade, and bladder-molding the shaft while partially seated within the cured hosel. The hosel can be tapered to have a toe-to-heel width that decreases and a side-to-side width increases as the hosel extends upwardly from the blade. The hosel can extend greater than the length of the blade to emphasize the gradual transition from the blade cross-section to the shaft cross-section. The resulting hockey stick can improve energy transfer during play while also providing a streamlined appearance and an improved resistance to breaking.

### BACKGROUND OF THE INVENTION

The present invention relates to a composite hockey stick with superior playing characteristics and a related method of manufacture.

Contemporary hockey sticks generally include a blade and a shaft each being formed of a fiber material disposed within a matrix material. Such sticks are generally termed “composite” hockey sticks to distinguish over traditional wood hockey sticks. Despite their being somewhat more expensive than comparable wood sticks, composite hockey sticks have gained widespread acceptance in nearly all levels of competition. The advantages of composite hockey sticks can include a generally lighter feel and a quicker release during passing and shooting motions, as well as improved puck control during play.

A number of methods have been proposed for forming a composite hockey stick having improved qualities over traditional wood hockey sticks. According to one known method, one or more core elements are overlaid with plies of fiber to form an uncured blade pre-form. The uncured blade pre-form is then inserted into a mold having the desired exterior shape of a blade. After the mold is sealed, a suitable matrix material or resin is injected into the mold to impregnate the blade pre-form. The blade pre-form is cured for the desired time and removed from the mold. A cured shaft, formed separately but according to the same process, can be dimensioned to interfit with the blade, and the blade and the shaft are then bonded together using an adhesive to cement the blade to the shaft.

According to another method for forming a composite hockey stick, a plastic bladder is inserted into a blade pre-form. The bladder and the blade pre-form are then placed within a mold having the desired exterior shape of a blade. One end of the plastic bladder can extend out of a tennon in the heel of the blade pre-form, and can be pressurized to force the pre-form to take on the shape of the mold. The blade pre-form is then cured for the desired time and removed from the mold. A cured shaft, formed separately but according to the same process, can be dimensioned to interfit with the blade. The cured blade and the cured shaft can be bonded together using an adhesive to cement the blade to the shaft. Alternatively, the shaft can be bladder-molded while partially seated within a cavity in the heel of the blade. For example, a shaft pre-form can be pressed into a heel cavity before being bladder-molded to take on the shape of the mold. According to this method, the shaft pre-form is fused to the hockey blade during the cure, avoiding the need for additional steps to adhere the shaft and blade together.

While composite sticks manufactured according to the above methods have been shown to have improved qualities over comparable wood hockey sticks, they can suffer from a number of drawbacks. For example, such hockey sticks can be prone to fracture at the blade-shaft interface during play and perhaps especially during shooting motions. In addition, composite sticks manufactured according to the above methods can have an unbalanced feel, particularly if there is a region of excessive overlap between the blade and the shaft. Moreover, such sticks can lack a desired torsional stiffness and can otherwise lack precision in puck control and release.

Accordingly, there remains a continued need for an improved composite hockey stick and a method for forming such a composite hockey stick. In particular, there remains a need for an improved method for leveraging the benefits of composite materials to provide a hockey stick with superior playing characteristics.

### SUMMARY OF THE INVENTION

An improved hockey stick and method for manufacturing the hockey stick is provided. The hockey stick can include a blade joined with an elongated hosel that transitions to a shaft. The elongated hosel can be tapered to flatten and widen as it extends upwardly from the blade to provide improved energy transfer during play and improved resistance to breaking, while also providing a streamlined appearance. The method can generally include providing a cured blade, bladder-molding an elongated hosel while partially seated within the cured blade, and bladder-molding a shaft while partially seated within the cured hosel.

According to one embodiment, the method includes forming an elongated hosel extending between a blade and a shaft of a hockey stick. The method can include overlaying a tapered mandrel with plies of fibers to create an uncured hosel, pressing the uncured hosel partially within the heel of a cured blade, placing the uncured hosel within a mold having the exterior shape of a tapered hosel, and bladder molding the hosel to cure the fibers in a hardened resin matrix. The resulting hosel can have a toe-to-heel width that decreases and a side-to-side width that increases as the hosel extends upwardly from the heel of the blade. Optionally, the hosel can extend greater than twice the length of the blade to emphasize the gradual transition from the blade to the shaft or handle of the stick.

According to another embodiment, the method includes molding the shaft while the shaft is partially seated within an upper portion of a tapered hosel. The method can include overlaying a mandrel of relatively constant cross-section with plies of fibers to create an uncured shaft. Optionally, the plies of fiber can be wrapped in a direction opposite that of the hosel. The mandrel can be removed from the shaft. With the mandrel removed, the fiber-resin construct is partially pressed and/or inserted within an opening in the tapered hosel and then loaded into a mold shaped to correspond to the exterior of the shaft. The fiber-resin construct is then bladder-molded to fuse the newly cured shaft to the tapered hosel. The shaft can include a generally constant cross-section corresponding with the cross-section of the tapered hosel at its upper opening. Further steps can include deburring and/or painting to conceal the shaft-hosel interface.

According to another embodiment, the method includes bladder-molding a tapered hosel while partially inserted within a preformed blade and subsequently bladder molding a shaft while partially inserted within the elongated hosel. More specifically, the method can include wrapping multiple plies of fiber over a tapered mandrel to form an uncured hosel, bladder molding the uncured hosel within a first mold while partially inserted within the cured blade, wrapping multiple plies of fiber to form an uncured shaft, and bladder molding the uncured shaft within a second mold while partially inserted within the cured hosel. The resulting hockey stick can include a blade transitioning to a shaft through an elongate, tapered hosel of continuously varying cross-section.

According to yet another embodiment, the hosel cross-section can include optionally a 0.5%-4.0% decrease in toe-to-heel width per unit length and a 1.0%-6.0% increase in side-to-side width per unit length as the hosel extends upwardly from the blade. Even further optionally, the hosel cross-section can include approximately a 1.0% decrease in toe-to-heel width per unit length and approximately a 2.0% increase in side-to-side width per unit length as the hosel extends upwardly from the blade. Still further optionally, the hosel can include a 5%-15% decrease in toe-to-heel width and a 15%-35% increase in side-to-side width over the length of the hosel as the hosel transitions from the blade to the shaft. Still optionally, the hosel can include an 8% reduction in toe-to-heel width and a 26% increase in side-to-side width over approximately ten inches as the hosel transitions from the blade to the shaft.

The embodiments herein can provide an improved method for manufacturing a composite hockey stick having enhanced torsional stiffness, a streamlined appearance, and a lightweight, balanced feel over existing composite hockey sticks. The embodiments can also provide an improved method for fusing a tapered hosel to a blade and/or a shaft without the time consuming addition of one or more inserts, potentially reducing manufacturing costs over known manufacturing methods, both in terms of time and manpower.

These and other advantages and features of the invention will be more fully understood and appreciated by reference to the description of the current embodiments and the drawings.

### BRIEF DESCRIPTION OF THE DRAWINGS

FIG. 1 is a perspective view of a hockey stick formed in accordance with an embodiment of the invention.

FIG. 2 is a first side view of the hockey stick of FIG. 1.

FIG. 3 is a bottom view of the hockey stick of FIG. 1.

FIG. 4 is a second side view of the hockey stick of FIG. 1 illustrating the cross-section of the hockey stick at various locations along the hosel.

FIGS. 4A-4C are cross-sectional views of the hockey stick of FIG. 4.

FIG. 5 is a first flow chart for a method of manufacturing the hockey stick of FIGS. 1-4.

FIG. 6 is a second flow chart for a method of manufacturing the hockey stick of FIGS. 1-4.

FIG. 7 is a third flow chart for a method of manufacturing the hockey stick of FIGS. 1-4.

FIG. 8 is a diagram of the cured blade and the uncured hosel assembled in an open molding prior to curing.

FIG. 9 is a diagram of the cured hosel and the uncured shaft assembled in an open molding prior to curing.

### DESCRIPTION OF THE CURRENT EMBODIMENTS

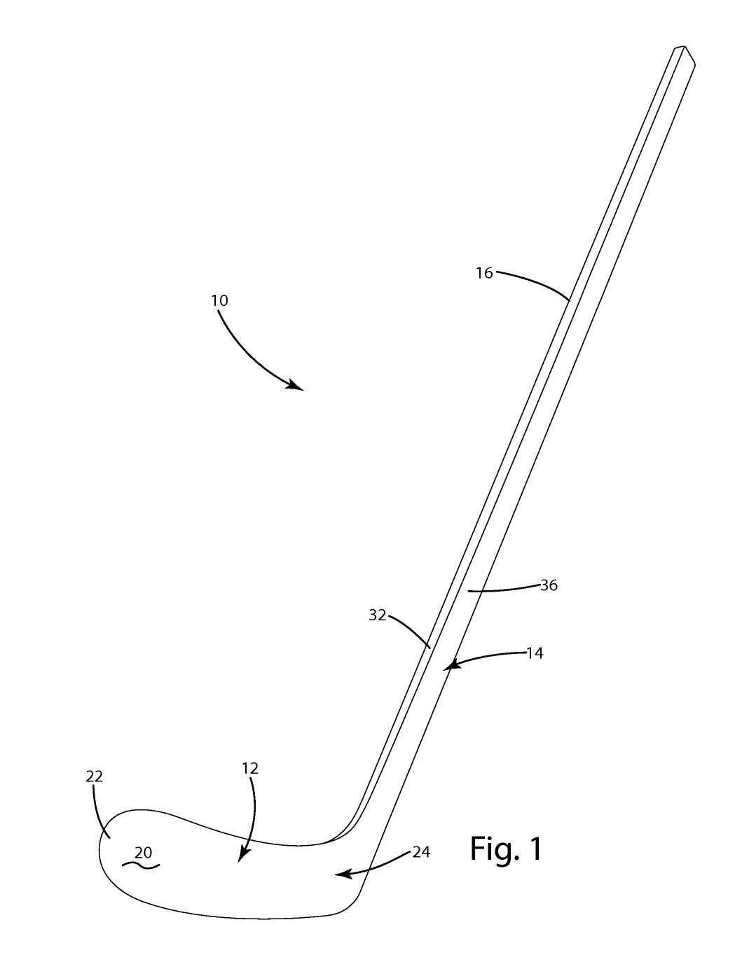

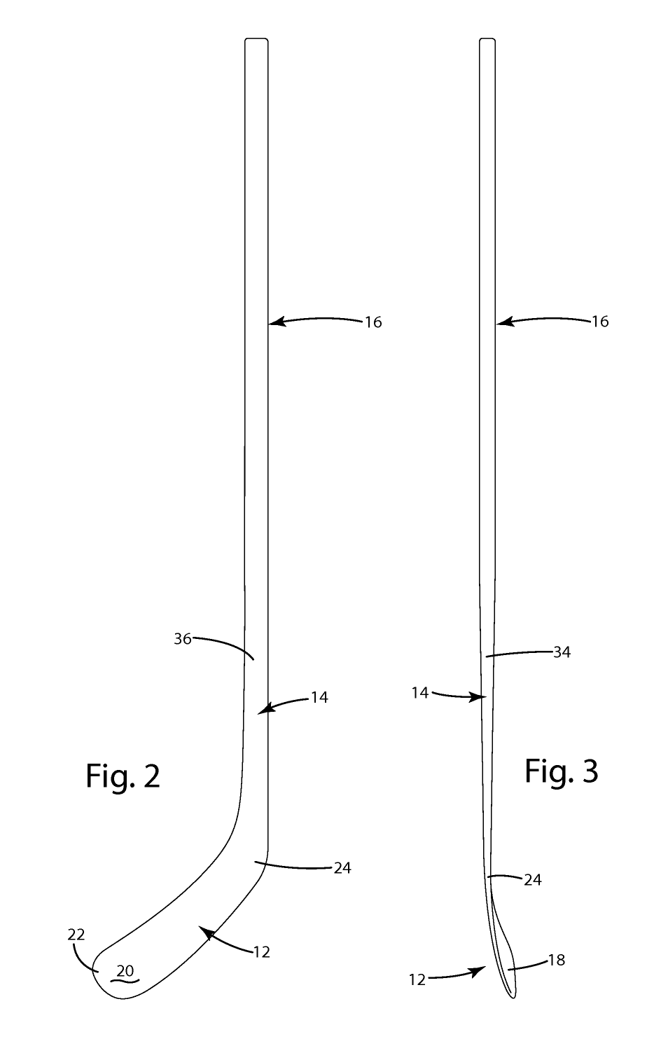

The current embodiments relate to a composite hockey stick and a method for forming the same. For illustrative purposes, the current embodiment is described in connection with a one piece hockey stick as generally shown in FIGS. 1-4. However, it should be noted that the embodiments therein can be used in connection with a wide variety of hockey sticks, including hockey sticks whose size and dimensions vary from that of the hockey stick shown in FIGS. 1-4, hockey sticks adapted for left- or right-handed use, and hockey sticks adapted for ice and/or non-slip surfaces, for example.

Referring now to FIGS. 1-4, the hockey stick is shown and generally designated 10. The hockey stick 10 includes a blade 12, a hosel 14, and a shaft 16. The blade 12 includes a front face 18 and a rear face 20 disposed opposite each other to generally define a blade width. In addition, the blade 12 includes a toe portion 22 and a heel portion 24 to generally define a blade length. The heel portion 24 can include a neck portion 26 that extends upwardly to define an aperture 28 sized to slideably receive a hosel 14. The blade 12 can further include a core element 30, for example a flexible foam element, that extends in an interior portion of the blade between the toe portion 22 and the heel portion 24.

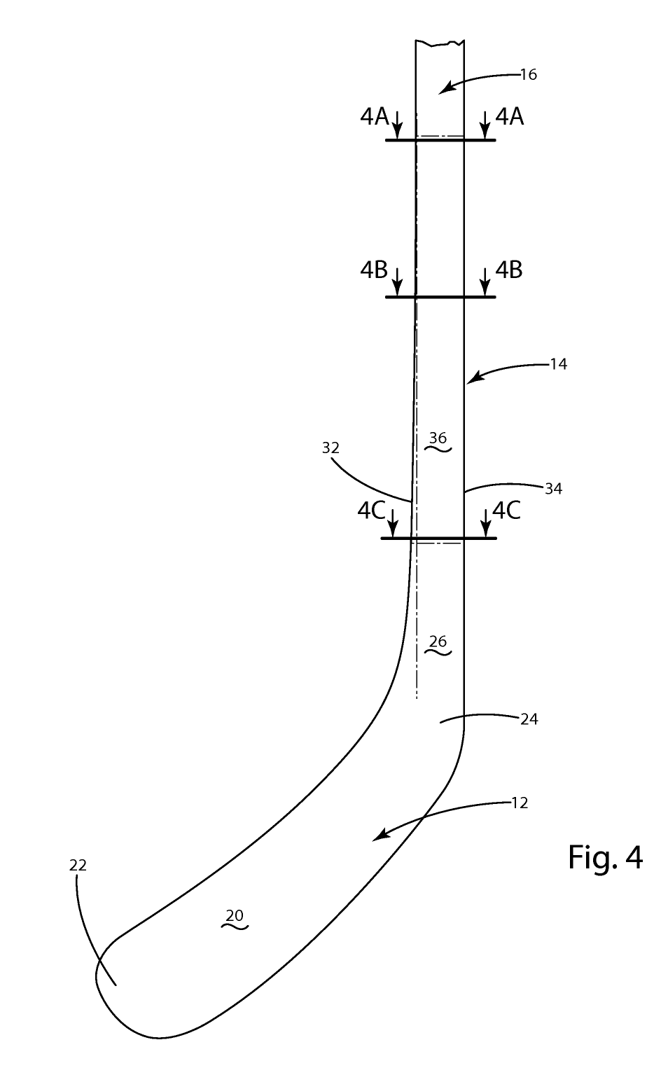

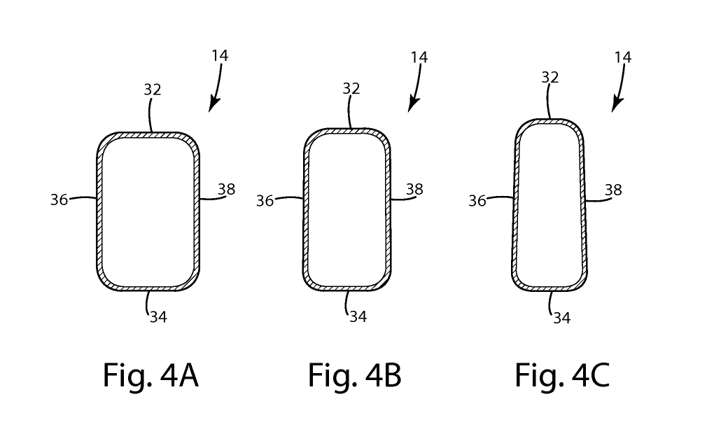

The hosel 14 can include a front surface 32, a back surface 34, a left side surface 36 and a right side surface 38. The hosel 14 is optionally dimensioned to be generally flush with the adjacent neck portion 26. That is, the hosel 14 can be generally complimentary to the neck portion 26 to provide a continuous or nearly continuous lower interface 40 between the blade 12 and the hosel 14. The hosel 14 can also define a continuously varying cross-section along a substantial portion of its length. As perhaps best shown in FIGS. 4 and 4A-4C, the toe-to-heel width decreases as the hosel 14 transitions upwardly from the blade 12, with the toe-to-heel width being defined as the dimension between the hosel front surface 32 and the hosel back surface 34. In addition, the side-to-side width is shown as increasing as the hosel 14 transitions upwardly from the blade 12, with the side-to-side width being defined as the dimension between the hosel left side surface 36 and the hosel right side surface 38.

The variation in hosel cross-section can depend on a number of factors, including the length of the overall hosel 14 and the cross-sections of the neck portion 26 and the shaft 16. In the illustrated embodiment, the hosel 14 can include a continuous 0.5%-4.0% decrease in toe-to-heel width per unit length, and can include a continuous 1.0%-6.0% increase in side-to-side width per unit length. For example, the hosel cross-section can include approximately a 1.0% decrease in toe-to-heel width per unit length and approximately a 2.0% increase in side-to-side width per unit length as the hosel extends upwardly from the blade. In other embodiments, the hosel cross-section will vary outside of this range. In addition, the hosel cross-section can include a 5%-15% decrease in toe-to-heel width and a 15%-35% increase in side-to-side width over the length of the hosel as the hosel transitions from the blade to the shaft. For example, the hosel 14 can include an 8% decrease in toe-to-heel width over the length of the hosel 14, and can include a 26% increase in side-to-side width over the length of the hosel 14. Other embodiments may vary outside of this range. In addition, the length of the hosel can vary, being optionally between 8 inches and 24 inches. The length of the hosel can also be described as being approximately the length of the blade as generally measured toe-to-heel, optionally between one-half and three times the length of the hockey blade.

The hosel 14 can be generally thin walled, extending between a tapered periphery 42 coincident with the neck portion 26 and a non-tapered periphery 44 coincident with the shaft 16. In the illustrated embodiment, the wall thickness remains constant, even as the overall cross-section of the hosel 14 varies. In other embodiments, however, the wall thickness will vary along all or a portion of the length of the hosel 14. The shaft 16 is generally rigidly coupled to the hosel 14 and includes two sets of opposed walls 46, 48, 50, 52. The opposed walls cooperate to define a substantially rectangular cross-sectional shape throughout the length of the shaft 16. While shown as including a generally rectangular cross-sectional shape, it should be noted that the shaft 16 can include a generally hexagonal, octagonal, decagonal, elliptical cross-sectional shape, or combinations thereof. In addition, the shaft wall thickness can remain constant or can vary along all or a portion of the length of the shaft 16. The shaft 16 can further include a mating section 54 bonded to the interior of the hosel 14 along a portion of its length. The shaft 16 can be generally flush with the adjacent hosel 14, and the blade 12, the hosel 14 and the shaft 16 cooperate to provide a streamlined appearance when viewed from the top, bottom and sides.

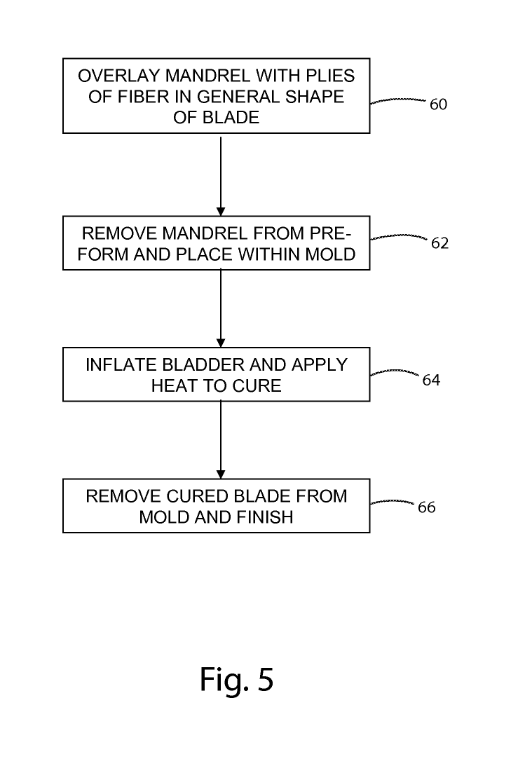

The hockey stick 10 having been briefly described, a method for forming the hockey stick 10 can be understood with reference to FIGS. 5-9. The method can generally include providing a cured blade, bladder-molding a tapered hosel while partially seated within the cured blade, and bladder-molding a shaft while partially seated within the cured hosel. With reference to the flow diagram of FIG. 5, the blade 12 can be formed according to the following steps. At step 60, one or more plies of substantially continuous fiber can be wrapped over a mandrel and/or an inner foam core 30, either or both of which being generally in the shape of a blade. The foam core 30 may include expanding foams such as polyurethane, PVC, epoxy, or other material having the desired weight or density. The fiber plies can include a carbon fiber, for example a uni-directional Kevlar® fiber manufactured by Dupont of Wilmington, Del., though other fibers can also be utilized. In the present embodiment, the fiber plies are pre-impregnated with a resin prior to the uncured blade assembly being inserted into a mold. In other embodiments, however, a suitable resin is inserted into the mold after the blade pre-form is inserted into the mold. At step 62, the mandrel can be removed to provide a blade pre-form, and the blade pre-form can be placed within a mold having the desired exterior shape of the blade 12. At step 64, an air bladder inserted in the blade pre-form can inflate within the closed mold, thereby creating pressure to force the fiber and the resin against the mold until the pre-form cures. A suitable air bladder can include a nylon bladder, while other air bladders can also be utilized. The cured blade can be removed from the mold at step 66, and can include a toe portion 22, a heel portion 24, and a neck portion 26 extending therefrom. The blade 12 may be finished to achieve a desired appearance prior to or after attachment to the hosel. In the present embodiment, the finishing process can include aesthetic aspects such as painting or polishing and can include structural aspects such as deburring. Once the blade 12 is finished, the blade 12 is ready for attachment to a hosel 14.

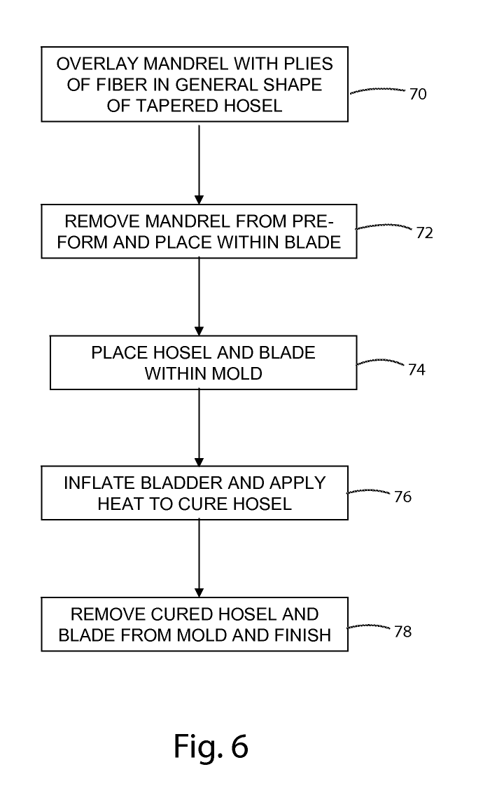

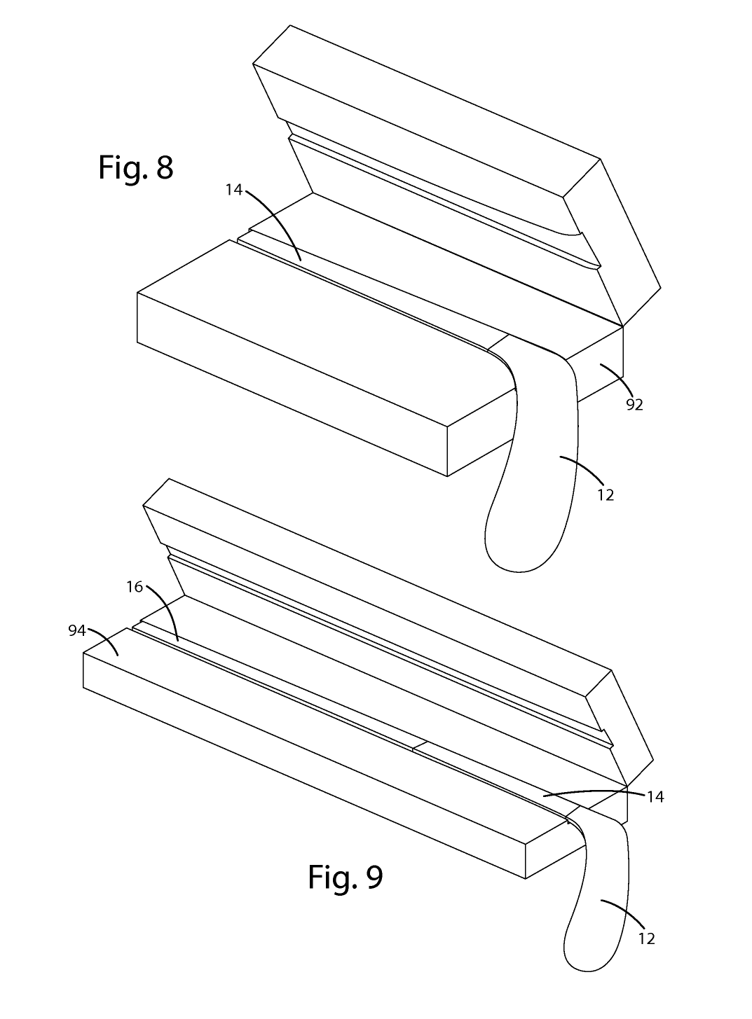

The method of the present embodiment can further include forming the tapered hosel 14 as described below in connection with FIG. 6. At step 70, the method can generally include overlaying one or more plies of substantially continuous fiber over a tapered mandrel generally in the shape of the tapered hosel. For example, the tapered mandrel can define a continuously varying cross-section, increasing in a first dimension and decreasing in a second dimension along a substantial portion of its length. At step 72 the tapered mandrel can be removed to provide a hosel pre-form, and the hosel pre-form can be pressed to extend at least partially within the cured blade 12. In some embodiments, the hosel pre-form will extend approximately four or more inches within the blade 12 before terminating at the core element 30. In addition, the hosel pre-form can be oversized relative to the opening in the blade 12 to provide an interference fit between the generally flexible pre-form and the generally rigid blade 12. At step 74, the combined blade 12 and hosel pre-form can then be placed within a mold 92 having the desired exterior shape of the tapered hosel 14. The blade 12 can be partially or completely positioned within the mold 92 to cure the portion of the hosel extending within the blade 12 as shown in FIG. 8. At step 76, an air bladder inserted in the hosel pre-form can inflate within the closed mold 92, thereby creating pressure to force the fiber and the resin against the mold. The pressurized air within the bladder provides an internal pressure to assist in ensuring the fiber plies take on an accurate rendition of the mold as it is cured. Heat is then applied to the mold 92 to cure the hosel 14, and the cured hosel is removed from the mold—now fused to the blade 12—and optionally finished to the desired appearance at step 78.

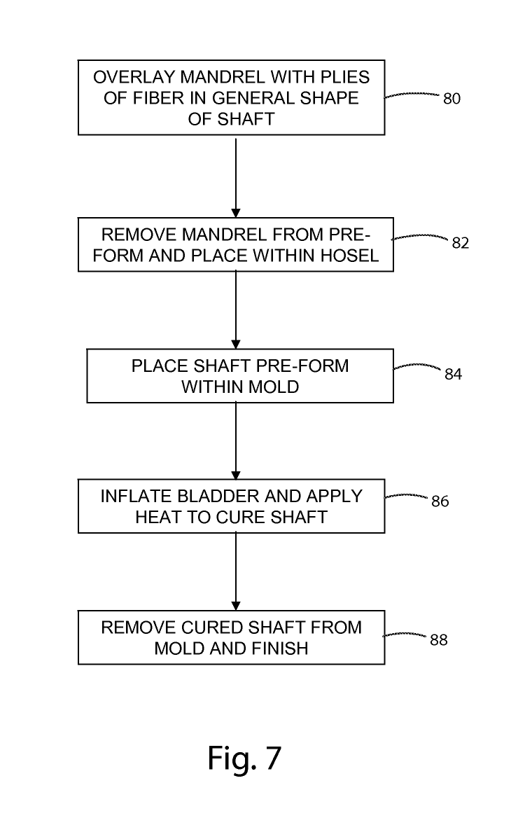

The above process of forming the hosel 14 while partially within the blade 12 can be performed in related fashion to form a shaft 16 while partially within the hosel 14. Referring now to the flow diagram of FIG. 7, forming the shaft 16 can include overlaying one or more plies of substantially continuous fiber over a mandrel at step 80. At step 82 the mandrel can be removed to provide a hollow shaft pre-form, and the shaft pre-form can be pressed at least partially within the cured hosel 14. The shaft pre-form can be oversized relative to the opening in the hosel 14 to provide an interference fit between the generally flexible pre-form and the generally rigid hosel 14. At step 84, at least a portion of the cured hosel 14 and the shaft pre-form can be placed within a mold 94 having the desired exterior shape of the shaft 16. For example, the hosel 14 can be partially positioned within the shaft mold 94 as shown in FIG. 9. At step 86, an air bladder inserted in the shaft pre-form can inflate within the closed mold 94, thereby creating pressure to force the fiber and the resin against the mold 94 until the shaft pre-form cures. The cured shaft can be removed from the mold 94 at step 88, and can be finished by painting, decaling, sanding or grinding any imperfections out from the mold finish. To provide a streamlined appearance, the tapered hosel 14 can be dimensioned such that hosel end portions are generally flush with adjacent portions of the finished blade 12 and of the finished shaft 14.

It should be noted that the materials employed to construct the hockey stick 10 may be varied either in quality or quantity to control the physical properties of the hockey stick 10, including its outer dimensions and general structure. For example, the fibers employed in the aforementioned plies can include carbon fiber, glass, polyethylene, ceramic, boron, quartz, polyester and combinations thereof. In addition, the resin applied to the aforementioned plies can include thermoplastics such as polyetherether-ketone, polyphenylene sulfide, polyethylene, polypropylene, urethanes, epoxy, vinylester, polycyanate, polyester and combinations thereof. The finished hockey stick 10 formed according to the present method can achieve an enhanced torsional stiffness in the tapered hosel 14 to improve energy transfer during play. At the same time, the tapered hosel 14 can improve the lateral flex of the stick in the region above the blade to improve puck release in passing motions and in shooting motions, including both slap shots and snap shops, for example. The stick 10 can also exhibit an improved resistance to breaking, particularly in response to inadvertent and in some instances intentional slashing of the forward portion of the stick 10.

The above descriptions are those of the current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A method for making a hockey stick comprising:
providing a cured hockey stick blade having a heel portion;
applying a material over a tapered mandrel to form an uncured hockey stick hosel;
placing the uncured hockey stick hosel within the heel portion of the cured blade; and
bladder-molding the uncured hosel so that the hosel expands and joins with the heel portion of the hockey stick blade, and so that the cured hosel rigidly joins with the cured blade and so that the cured hosel includes a cross-section that increases in a first dimension and decreases in a second dimension as the hosel extends away from the heel portion of the blade.

2. The method of claim 1 wherein bladder-molding includes placing the uncured hosel into a mold having the desired exterior shape of the cured hosel.

3. The method of claim 1 wherein said providing step includes defining an aperture in the heel portion of the blade, and wherein said placing step includes placing the uncured hockey stick hosel at least partially within the aperture.

4. The method of claim 1 wherein:
said providing step includes forming a blade that defines a length; and
said applying step includes forming an uncured hosel extending greater than one half of length of the blade.

5. The method of claim 1 wherein said applying step includes forming a hosel that defines an upper opening for attachment to a shaft.

6. The method of claim 1 wherein said bladder-molding step includes forming a cured hosel that defines a toe-to-heel width that flattens as it extends upwardly from the hockey blade and forming a hosel that defines a side-to-side width that widens as it extends upwardly from the hockey blade.

7. A method for forming a hockey stick comprising:
providing a tapered hosel including a continuously varying cross-section along a substantial portion of its length, the hosel terminating at a shaft end at which it defines an opening;
overlaying a mandrel with plies of fiber to define an uncured shaft; and
bladder-molding the uncured shaft while partially seated within the hosel opening to obtain a cured shaft, wherein the cured shaft includes a substantially constant cross-section that is flush with the tapered hosel at the hosel opening.

8. The method of claim 7 further comprising:
defining with the hosel an interior surface spaced apart from an exterior surface; and
fusing a neck portion of the shaft with the interior surface of the hosel.

9. The method of claim 7 wherein the hosel cross-section increases in a first dimension and decreases in a second dimension along a substantial portion of its length.

10. The method of claim 7 further comprising fixedly joining the hosel to a hockey blade.

11. The method of claim 10 further comprising defining within the hockey blade a neck portion having a cross-section, wherein the hosel assists in a gradual transition from neck cross-section to the shaft cross-section.

12. The method of claim 10 further comprising defining with the hockey blade a length, wherein the hosel extends greater than the length of the hockey blade.

13. A method for making a composite hockey stick comprising:
providing a cured blade defining a socket that includes an aperture defined by an outer surface of the blade;
inserting an uncured hosel in the socket, wherein a substantial portion of the hosel extends outside of the socket;
bladder-molding the uncured hosel in a first mold to obtain a cured hosel rigidly fused to the blade, the cured hosel terminating in a periphery distal from the blade to define an opening, wherein the cured hosel defines a continuously varying cross-section along a substantial portion of its length;
inserting an uncured shaft with the opening, wherein a substantial portion of the uncured shaft extends outside of the opening; and
bladder-molding the uncured shaft in a second mold while partially seated within the hosel opening to obtain a cured shaft, wherein the cured shaft defining a substantially uniform cross-section extending from the hosel to and end portion of the cured shaft.

14. The method of claim 13 wherein bladder-molding the uncured hosel includes forming a cured hosel that defines a toe-to-heel width that flattens as it extends upwardly from the hockey blade and that defines a side-to-side width that widens as it extends upwardly from the hockey blade.

15. The method of claim 13 further comprising:
defining with the cured hosel an interior surface spaced apart from an exterior surface; and
fusing a neck portion of the shaft with the interior surface of the hosel.

16. The method of claim 13 further comprising overlaying a tapered mandrel with plies of fiber to form the uncured hosel.

17. The method of claim 13 further comprising:
wrapping fibers in a resin matrix about a core element to form a blade structure;
placing the blade structure into a third mold having the desired exterior shape of the blade; and
bladder-molding the blade structure for a selected period of time and at a selected temperature to obtain a cured blade having fibers wound in a hardened resin matrix.

18. The method of claim 17 wherein during said wrapping step the plies of fiber are wrapped about a foam core element.

19. The method of claim 13 wherein:
the cured hosel includes first and second end portions defining a length therebetween, the cured hosel further defining a width transverse to the hosel length; and
the hosel includes approximately a one percent to a six percent increase in side-to-side width per unit length and approximately a one-half percent to a four percent decrease in toe-to-heel width per unit length.

20. The method of claim 19 wherein the hosel includes approximately a two percent increase in side-to-side width per unit length and approximately a one percent decrease in toe-to-heel width per unit length.
